(19) United States
(12) Patent Application Publication
(10) Pub. No.: US 2012/0229813 A1
(43) Pub. Date: Sep. 13, 2012

(54) WAVELENGTH DETECTOR AND OPTICAL COHERENCE TOMOGRAPHY HAVING THE SAME

(75) Inventors: Ki-Wan Kim, Daegu (KR); Man-Sik Jeon, Daegu (KR); Un-Sang Jung, Daegu (KR); Chang-Ho Lee, Daegu (KR)

(73) Assignee: EQ MED CO., LTD., Daegu (KR)

(21) Appl. No.: 13/501,049

(22) PCT Filed: Oct. 14, 2010
(86) PCT No.: PCT/KR10/07049

§ 371 Date: Apr. 9, 2012

(30) Foreign Application Priority Data
Oct. 15, 2009 (KR) 10-2009-0098200
Oct. 15, 2009 (KR) 10-2009-0098230

(51) Int. Cl. G01B 9/02; G01J 3/51

(52) U.S. Cl. 356/479; 250/226

(57) ABSTRACT

In a wavelength detector and an OCT including the same, the wavelength detector includes a wavelength filter by which at least one of the diffraction beams of a coherent input light is selected as a selection beam having a desired frequency by using a flat plate and at least a slit penetrating through the flat plate. The pixel having image data of an OCT image is mapped to the frequency of the selection beam by one to one, thereby improving uniformity of the resolution of the OCT image along a depth of the inspection object. The frequency of the selection beam is determined by an optical spectrum analyzer before initiating the OCT inspection to the object.

### TECHNICAL FIELD

Example embodiments of the present invention relate to a wavelength detector and an optical coherence tomography having the same. More particularly, example embodiments of the present invention relate to a wavelength detector for selectively detecting a light having a particular wavelength and an optical coherence tomography having the same.

### BACKGROUND ART

In general, an optical coherence tomography (OCT) captures high-resolution images in a real time from insides of various optical scattering media such as biological tissues and materials by using a harmless light. Particularly, the OCT usually uses a relatively short wavelength coherent beam such as an ultra-short pulsed laser beam and can obtain high resolution cross-sectional images of microstructures of the tissues and materials by the sub-micrometers. The OCT can reveal the microstructures of the biological tissues by a noninvasive and a noncontact modality with high resolution images and thus clearly distinguish the biological organisms such as cells or tissues.

The OCT has been widely used for a laser tomography in a diagnostic imaging, for an optical fiber sensor system and for an optical communication system. Most of the OCTs are classified into a frequency domain OCT (FDOCT) and a spectrum domain OCT (SDOCT) according to a mechanical structure and a basic operation theory. The SDOCT splits a low-coherence beam into frequency components by using a stationary reference mirror without instead of a moving reference mirror and simultaneously detects all of these frequency components. Each frequency detected corresponds to a certain depth within the tissue after a Fourier transform of the received signal. Particularly, when the tunable laser is used as a light source for the SDOCT, the SDOCT detects various bit signals according to each depth of the scattering medium and acquires the depth information of the scattering medium through a Fourier transform of the bit signals.

A conventional SDOCT usually uses a broadband light source. The broadband light source may be well split and reflected from the optical media an object in accordance with the frequency components and a spectrometer detects the intensity of each frequency component and generates digital images using some frequency components. A complementary metal oxide semiconductor (CMOS) camera and a charge-coupled device (CCD) have been widely used as the spectrometer. The spectrometer such as the CMOS camera and the CCD is equipped with the conventional SDOCT as a line type detector and a specific frequency of the broadband light source is designed to be mapped onto a specific pixel of the detector in the conventional SDOCT. In general, the pixels to which corresponding frequency components of the light are mapped, respectively, are arranged in a line due to the line type detector.

The SDOCT acquires a 3-dimensional image indicating the depth of the optical media through the Fourier transform of the combinations of the linear pixels. Thus, the resolution of the image requires being constant according to the depth of the optical media in the SDOCT. However, since the pixels of the detector are controlled to be linear, the resolution of the 3-dimensional image decreases with increasing the depth of the optical media. In addition, the frequency components of the light source are difficult to be linear due to a diffraction grating in an actual SDOCT, and thus the decrease of the resolution tends to be deteriorated.

For those reasons, a wavelength calibration has been usually conducted to the conventional SDOCT by using a Fabry-Perot interferometer or a Fiber-Bragg grating.

However, the wavelength calibration using the Fabry-Perot interferometer or the Fiber-Bragg grating costs high and still requires mechanical operations and complicated alignments which usually increase operational instability of the SDOCT.

### DISCLOSURE

### Technical Problem

Example embodiments of the present invention provide a wavelength detector for detecting frequency components of a source light for an OCT.

Further, example embodiments of the present invention provide an OCT including the above wavelength detector.

### Technical Solution

According to an aspect of the present invention, there is provided a wavelength detector including a first collimator transforming an input light into a straight light, a first diffraction grating diffracting the straight input light into a plurality of diffraction beams that are split according to frequencies thereof, a first focusing lens focusing the diffraction beams to a first focal point, a wavelength filter positioned on the focal point such that the diffraction beams are selectively filtered, thereby selecting at least a selection beam having a desired frequency, and a light supplying unit emitting the selection beam outwards. The input light is generated from an external light source.

In an example embodiment, the wavelength filter includes a flat plate and a single slit penetrating the flat plate in such a configuration that one of the diffraction beams having the desired frequency corresponding to the slit passes through the slit of the wavelength filter to thereby select the single selection beam, so that a plurality of selection beams are selected by reciprocating the flat plate of the wavelength filter in a direction along which the diffraction beams are distributed as a spectrum distribution with respect to the frequencies thereof.

In an example embodiment, the wavelength detector includes an inlet through which the input light passes into the wavelength detector and an outlet through which the selection beam emits out of the wavelength detector, the inlet and the outlet being arranged at different positions individually, so that the input light is transformed into the selection beam in the wavelength detector and the selection beam passes out of the wavelength detector along an optical path different from that of the input light in the light supplying unit. In such a case, the light supplying unit includes a second focusing lens for focusing the selection beam that is selected by the wavelength filter, a second diffraction grating diffracting the selection beam that is focused by the second focusing lens, and a second collimator transforming the selection beam into a straight beam.

In an example embodiment, the wavelength detector includes an inlet through which the input light passes into the wavelength detector and an outlet through which the selection beam emits out of the wavelength detector. The inlet and the outlet are arranged at a same position, so that the input light is transformed into the selection beam in the wavelength detector and the selection beam passes out of the wavelength detector along a same optical path of the input light after reflected from the light supplying unit. In such a case, the light supplying unit includes a reflection mirror, so that the selection beam emits out of the wavelength detector sequentially passing through the wavelength filter, the first focusing lens, the first diffraction grating and the first collimator.

In an example embodiment, the first diffraction grating includes a two-way lattice plate on which a plurality of incidence lattices and a plurality of reflection lattices are mounted such that the input light is guided to the first focusing lens from the first collimator by the incident lattices to thereby form an optical incidence path and the selection beam may be guided to the first collimator from the first focusing lens by reflection from the reflection lattices to thereby form an optical reflection path reverse to the optical incidence path.

In an example embodiment, the wavelength filter includes a flat plate and a plurality of slits penetrating the flat plate and in parallel with one another in such a configuration that some of the diffraction beams having the desired frequencies corresponding to each slit pass through the slits of the wavelength filter, respectively, to thereby select a plurality of the selection beams without reciprocating the flat plate.

In an example embodiment, the slits include circular or polygonal openings penetrating through the flat plate and spaced apart by the same gap distance.

In an example embodiment, the frequency of the selection beam is measured by an optical spectrum analyzer.

In an example embodiment, when the wavelength filter includes a flat plate and a plurality of slits penetrating the flat plate, the light supplying unit also includes a second focusing lens for focusing the selection beam that is selected by the wavelength filter; a second diffraction grating diffracting the selection beam that is focused by the second focusing lens; and a second collimator transforming the selection beam into a straight beam. Otherwise, the light supplying unit also includes a reflection mirror, so that the selection beam emits out of the wavelength detector sequentially passing through the wavelength filter, the first focusing lens, the first diffraction grating and the first collimator. In such a case, the first diffraction grating includes a two-way lattice plate on which a plurality of incidence lattices and a plurality of reflection lattices are mounted such that the input light is guided to the first focusing lens from the first collimator by the incident lattices to thereby form an optical incidence path and the selection beam may be guided to the first collimator from the first focusing lens by reflection from the reflection lattices to thereby form an optical reflection path reverse to the optical incidence path.

According to another aspect of the present invention, there is provided an optical coherence tomography (OCT) including a light source for generating a broadband input light having a low coherence distance; a wavelength detector diffracting the input light into a plurality of diffraction beams and selecting at least one of the diffraction beams as a selection beam having a desired frequency; a coupler splitting the selection beam into first and second split beams and interfering a pair of a signal beam and a reference beam into a single interference beam; a sample unit in which an inspection object is positioned and to which the first split beam is transferred from the coupler, the sample unit forming the signal beam having optical information on internal structures of the inspection object by reflecting the first split beam from the inspection object; a reference unit to which the second split beam is transferred from the coupler, the reference unit forming the reference beam by reflecting the second split beam therefrom; and a measuring unit detecting the selection beam and the interference beam from the coupler, the measuring unit generating a digital image on the inspection object such that pixels having image data for the digital image are mapped to the frequency of the selection beam by one to one.

In an example embodiment, the wavelength detector includes a first collimator transforming the input light into a straight light; a first diffraction grating diffracting the straight input light into a plurality of diffraction beams that are split according to frequencies thereof; a first focusing lens focusing the diffraction beams to a first focal point; a wavelength filter positioned on the focal point such that the diffraction beams are selectively filtered, thereby selecting at least a selection beam having a desired frequency; and a light supplying unit emitting the selection beam outwards.

In an example embodiment, the wavelength filter includes a flat plate and a single slit penetrating the flat plate in such a configuration that one of the diffraction beams having the desired frequency corresponding to the slit passes through the slit of the wavelength filter to thereby select the single selection beam, so that a plurality of selection beams are selected by reciprocating the flat plate of the wavelength filter in a direction along which the diffraction beams are distributed as a spectrum distribution with respect to the frequencies thereof.

In an example embodiment, the wavelength filter includes a flat plate and a plurality of slits penetrating the flat plate and in parallel with one another in such a configuration that some of the diffraction beams having the desired frequencies corresponding to each slit pass through the slits of the wavelength filter, respectively, to thereby select a plurality of the selection beams without reciprocating the flat plate.

In an example embodiment, the wavelength detector is interposed between at least one of a pair of the light source and the coupler, a pair of the coupler and the sample unit, a pair of the coupler and the reference unit and a pair of the coupler and the measuring unit.

In an example embodiment, the light source includes one of a light emitting diode (LED), a super luminescent diode (SLD), a laser diode (LD) and a frequency sweeping laser source.

In an example embodiment, the reference unit includes one of a moving reflector and a combination of a stationary reflector and a scattering corrector, the moving reflector being movable along an optical path of the second split beam and reflecting the second split beam to thereby form the reference beam using the movable reflector and the scattering corrector correcting spectrum characteristics of the second split beam reflected from the stationary reflector to thereby form the reference beam using the stationary reflector.

### Advantageous Effects

According to the example embodiments of the present invention, an input light for the OCT is diffracted into a plurality of diffraction beams and at least one of the diffraction beams having desired frequencies is selected as the select beams. The signal beam generated from the object and the reference beam generated from the reference unit may be obtained by reflecting the split beams of the selection beam. The OCT may obtain digital image data of the object with respect to the frequency of various selection beams. The pixel having the digital image information and the frequency of an optical beam for generating the digital image information may be mapped to each other by one to one, to thereby obtain the linearity between the pixel information and the frequency information. Accordingly, the OCT may obtain a 3-dimensional image of which the resolution may be uniform and have no image distortion. Particularly, when some portions of the OCT image are deteriorated at a particular pixel along the dept of the object, the frequency of the selection beam corresponding to the deteriorated pixel can be easily detected, and thus a particular beam just merely for the deteriorated pixel may be corrected for improving the resolution of the OCT image along the depth of the object.

### DESCRIPTION OF DRAWINGS

Example embodiments of the present invention will become readily apparent along with the following detailed description when considered in conjunction with the accompanying drawings, in which:

FIG. 1 is a bock diagram illustrating an OCT in accordance with a first example embodiment of the present inventive concept;

FIG. 2 is a structural view illustrating a wavelength detector of the OCT shown in FIG. 1;

FIG. 3 is a plan view illustrating the wavelength filter having a plurality of slits in accordance with an example embodiment of the present inventive concept;

FIG. 4 is a hock diagram illustrating an OCT in accordance with a second example embodiment of the present inventive concept; and

FIG. 5 is a structural view illustrating a wavelength detector of the OCT shown in FIG. 4.

### BEST MODE

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

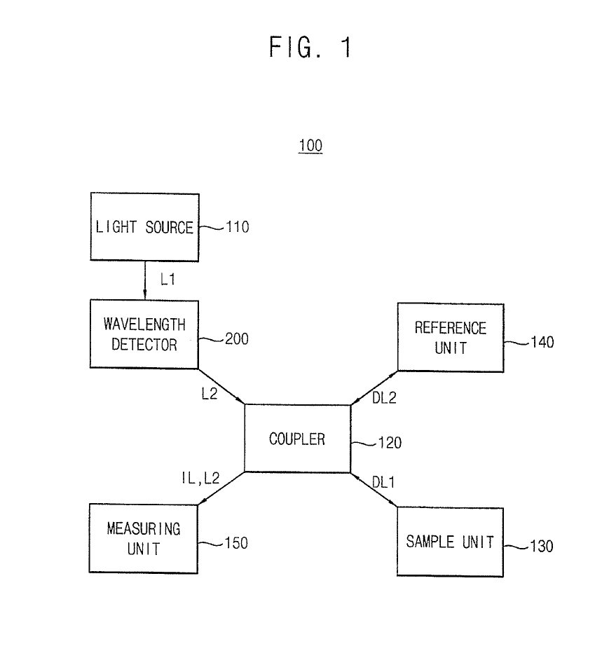

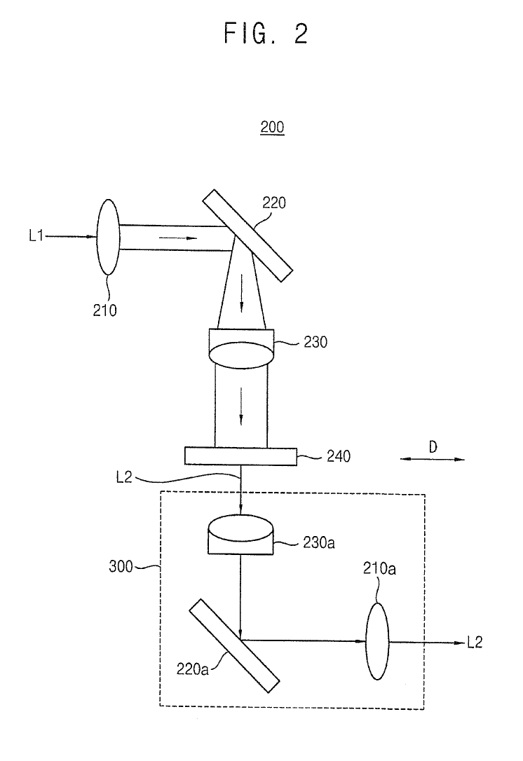

FIG. 1 is a bock diagram illustrating an OCT in accordance with a first example embodiment of the present inventive concept. FIG. 2 is a structural view illustrating a wavelength detector of the OCT shown in FIG. 1.

Referring to FIGS. 1 and 2, the OCT 100 in accordance with a first example embodiment of the present inventive concept may include a light source 110, a wavelength detector 200, a coupler 120, a sample unit 130, a reference unit 140 and a measuring unit 150.

The light source 110 may sequentially and continuously generate an input light L1 having a plurality of frequency components. For example, the light source 110 may be connected to the wavelength detector 200 via an optical fiber. However, the light source 110 may also be directly connected to the coupler 120 via the optical fiber without passing through the wavelength detector 200. The light source 110 may generate a high luminescent broadband beam having a low coherence distance. For example, the light source may include a light emitting diode (LED), a super luminescent diode (SLD), a laser diode (LD) and a frequency sweeping laser source. A signal beam reflected from an object such a biological tissue and a reference beam reflected from the reference unit 140 may be interfered with each other and the digital image showing internal structures of the object may be generated by detecting the interference of the signal beam and the reference beam.

The wavelength detector 200 may include a first collimator 210, a first diffraction grating 220, a first focusing lens 230, a wavelength filter 240 and a light supplying unit 300.

The first collimator 210 may transform the input light L1 radiated from the light source 110 into a parallel or a straight light and thus the input light L1 may be incident to the first diffraction grating 220 in parallel with a central axis of the first collimator 210.

The first diffraction grating 220 may split the input light L1 into frequency components thereof by diffraction and thus each frequency components of the input light L1 may be incident onto the first focusing lens 230. For example, the first diffraction grating 220 may include a flat glass plate or a concave metal plate on which a plurality of parallel lines may be engraved at a fine pitch, and thus the input light L1 may be split according to the component frequencies thereof. That is, the first light L1 may be scattered into spectrums corresponding to each component frequency by the first diffraction grating 220. For those reasons, the frequency component of the input light L1 is often referred to as a diffraction beam having a single frequency hereinafter.

The input light L1 may be diffracted into the diffraction beams by the first diffraction grating 220 and the diffraction beams may be focused onto the wavelength filter 240 by the first focusing lens 230.

The wavelength filter 240 may be positioned on a focal point of the first focusing lens 230 and may be reciprocated along a first direction D substantially perpendicular to an optical path of an incident light thereto. For example, the wavelength filter 240 may include a flat plate and a slit penetrating through the flat plate.

The reciprocal direction of the wavelength filter 240 may be varied in accordance with the spectrum distribution of the input light L1. In the present example embodiment, since the spectrum of the input light L1 may be distributed along the component frequencies in a direction perpendicular to the optical path of the focusing lens 230, the wavelength filter 240 may reciprocate along the first direction D and one of the frequency components of the input light L1, i.e., the diffraction beams having a specific wavelength may be selected by the wavelength filter 240. That is, when the wavelength filter 240 may be positioned under a spectrum of the input light L1 having the specific wavelength, a particular beam having the specific wavelength may pass through the wavelength filter 240 and thus the particular beam may be selected by the wavelength filter 240 as a selection beam L2. Therefore, one of the diffraction beams may be chosen as the selection beam L2 by the wavelength filter 240. However, when the spectrum of the input light L1 may be distributed in a direction parallel with the optical path of the focusing lens 230 in accordance with the frequency, the wavelength filter 240 may reciprocate in a direction perpendicular to the first direction D, as would be known to one of the ordinary skill in the art.

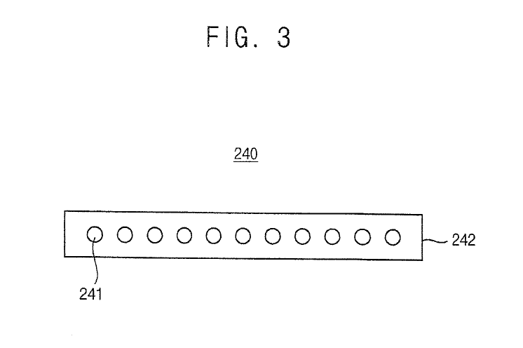

In a modified example embodiment, the wavelength filter 240 may include a plurality of slits penetrating through the flat plate in such a configuration that the slits may allow respective beams having different wavelengths to pass through toward the light supplying unit 300. That is, one or more of the diffraction beams may be chosen as the selection beams by one or more slits, respectively. FIG. 3 is a plan view illustrating the wavelength filter having a plurality of slits in accordance with an example embodiment of the present inventive concept.

Referring to FIG. 3, a plurality of the slits 241 may be arranged on the flat plate 242 and be spaced apart by the same gap distance. The size, shape, number and arrangement of the slits 241 on the flat plate 242 may be varied according to the requirements of the SDOCT and the operation conditions of the wavelength detector 100. While the present example embodiment discloses a circular opening on the flat plate 242 as the slit 241, any other modifications such as a rectangular opening and a polygonal opening may also be provided as the slit 241 in place of or in conjugation with the circular opening, as would be known to one of the ordinary skill in the art.

Since a particular diffraction beam having a frequency corresponding to the respective slit 241 may pass through each of the slits 241, the input light L1 may pass through the wavelength filter 240 by the frequency corresponding to each slit 241 after diffracted by the diffraction grating 220.

The wavelength filter 240 may be manufactured in such a manner that some of the diffraction beams having the desired frequencies may pass through the slits 241. Therefore, the position of the slits 241 of the wavelength filter 240 may indicate the wavelength of the corresponding diffraction beam passing through the slits 241. The wavelength of the diffraction beam passing through each slit 241 may be known in advance by using an analyzer such as an optical spectrum analyzer when manufacturing the wavelength filter 240. Accordingly, one or more selection beams having different frequencies may be selected by the wavelength filter 240. Particularly, when the wavelength filter 240 may include a plurality of slits 241, the diffraction beams having their own frequencies may be simultaneously selected as the selection beams L2 and thus the reciprocation of the wavelength filter 240 along the first direction D may be minimized in selecting a plurality of the selection beams L2. In such a case, a plurality of selection beams L2 may be simultaneously provided to the light supplying unit 300.

Accordingly, the input light L1 may be diffracted into the diffraction beams having their own frequencies by the first diffraction grating 220 and the diffraction beams may be focused onto the wavelength filter 240 by the first focusing lens 230. Some of the diffraction beams may be selected as the selection beams L2 and the rest of the diffraction beams may be filtered off by the wavelength filter 240. Thus, the selection beams L2 having the desired frequencies may be supplied to the light supplying unit 300.

For example, a first selection beam having a first frequency may be selected at a first position of the wavelength filter 240, and the OCT may obtain a first image by using the first selection beam. Then, the wavelength filter 240 may move to a second position from the first direction D and then a second beam having a second frequency may be selected by the wavelength filter 240. The OCT may obtain a second image by using the second selection beam. Thus, the diffraction beams diffracted from the input light L1 may be individually provided to the light supplying unit 300 by the wavelength filter 240 in a user's order that may be controlled by OCT users. Therefore, the image data may be generated in relation to each frequency of the diffraction beams and the pixels for detecting the image data may be mapped with the corresponding frequency by one to one. Particularly, the wavelength filter 240 may be controlled in such a way that the mapping between the pixels for detecting the image data and the frequency corresponding to the diffraction beam for generating the image data may become linear along the depth of the inspection object in the sample unit 130, thereby preventing the deterioration of the 3-dimensional image of the OCT along the depth of the object.

The light supplying unit 300 may include a second focusing lens 230a, a second diffraction grating 220a and a second collimator 210a. The second focusing lens 230a may focus the selection beam L2 onto the second diffraction grating 220a and the selection beam L2 may be diffracted toward the second collimator 210a by the second diffraction grating 220a. The second collimator 210a may reinforce the straightness of the selection beam L2, and thus the selection beam L2 may emit from the light supplying unit 300 as a sufficiently parallel or straight light. Accordingly, the input light L1 may be guided into the wavelength detector 200 through the first collimator 210 and one of the diffraction beams may be selected as the selection beam L2 having the desired frequency in the wavelength detector 200. Then, the selection beam L2 may be guided out of the wavelength detector 200 through the second collimator 210a. That is, the wavelength detector 200 include a transmitting type in which an inlet portion through which the input light L1 may pass into the wavelength detector 200 and an outlet portion through which the selection beam L2 may pass out of the wavelength detector 200 may be located at different positions.

Then, the selection beam L2 having the desired frequency may be incident onto the coupler 120 and subsequently transferred to the sample unit 130, the reference unit 140 and the measuring unit 150. For example, the selection beam L2 may include a spectrum having a width of about 0.5 nm.

While the present example embodiment discloses that the wavelength detector 200 is interposed between the light source 110 and the coupler 120, the wavelength detector 200 may be installed at any other positions as long as the wavelength detector 200 may be optically communicated with the coupler 120. For example, the wavelength detector 200 may be interposed between the coupler 120 and one of the sample unit 130, the reference unit 140, and the measuring unit 150, as would be known to one of the ordinary skill in the art.

The coupler 120 may be connected to the wavelength detector 200 via the optical fiber, and thus the selection beam L2 may be transferred into the coupler 120 from the wavelength detector 200 to the coupler 120 through the optical fiber. In an example embodiment, the coupler 120 may include a spectrometer such as a beam splitter and thus the selection beam L2 may be split into a first split beam DL1 and a second split beam DL2 in the coupler 120. In such a case, the first and the second split beams DL1 and DL2 may have various intensity ratios by controlling the beam splitter. In another example embodiment, the coupler 120 may further include a composition member such as an interferometer and thus two different optical beams may be composed into a single beam by interference. In the present example embodiment, the signal beam reflected from the inspection object of the sample unit 130 and the reference beam reflected from the reference unit 140 may be interfered with each other in the coupler 120, to thereby form a single composite beam.

The first split beam DL1 may be incident onto the sample unit 130 and the second split beam DL2 may be incident onto the reference unit 140 by the coupler 120. Then, the first split beam DL1 may be reflected from the inspection object in the sample unit 130 toward the coupler 120 as the signal beam and the second split beam DL2 may be reflected from the reference unit 140 toward the couple 120 as the reference beam. Then, the signal beam and the reference beam may be interfered with each other by the interferometer in the coupler 120, thereby forming a single interference beam IL. The interference beam IL may be supplied to the measuring unit 150.

The inspection object such as the biological tissue may be mounted into the sample unit 130 and the first split beam DL1 may be irradiated onto the object. For example, the sample unit 130 may be connected to the coupler 120 via an optical fiber and thus the first split beam DL1 may be efficiently transferred to the sample unit 130 from the coupler 120. The first split beam DL1 may be reflected or scattered from the inspection object in various modes according to the shape and internal structure of the object, and thus the signal beam may be varied according to the shape and internal structure of the object. That is, the signal beam may include the optical information on the shape and the internal structure of the object.

The reference unit 140 may provide a reference position for generating a cross-sectional image at a particular depth of the inspection object as the reference beam. The reference beam may be interfered with the signal beam in the coupler 120 and the interference beam IL may be detected by a detector such as a CCD and a CMOS device along the depth of the object, thereby forming the 3-dimensional image on the object.

For example, the reference unit 140 may include a moving reflector that may be movable along an optical path of the second split beam DL2, and thus the OCT 100 may function as a time-domain OCT (TDOCT) in which the position variation of the moving reflector may cause the variation of the reference beam. For example, the first split beam DL1 may be reflected from a cross-sectional surface of the inspection object at first and second positions along the depth of the object, respectively, to thereby form first and second signal beams, respectively, in the sample unit 130. The second split beam DL2 may be reflected from first and second positions of the reference unit 140, respectively, to thereby form first and second reference beams, respectively, in the reference unit 140. In such a case, the first and second positions of the reference unit 140 may correspond to the first and second positions of the cross-sectional surfaces of the object. The first signal beam may be interfered with the first reference beam and the second signal beam may be interfered with the second reference beam, and thus the first and second interference beams may include the optical information on the first and the second cross-sectional surfaces of the object. In the same way, a plurality of the interference beams corresponding to every cross-sectional surfaces of the inspection object along the depth from a top portion to a bottom portion thereof may generate the 3-dimensional image on the object.

In contrast, the reference unit 140 may include a stationary reflector that may stand at a particular point without moving and a scattering corrector for correcting the spectrum characteristics of the reference beam reflected from the stationary reflector, and thus the OCT 100 may function as a spectrum-domain OCT (SDOCT) in which the reference beam may be modified in view of the positions of the inspection object along the depth. The scattering corrector may modify the optical characteristics of the reference beam reflected from the stationary reflector in accordance with every position corresponding to the cross-sectional surfaces of the inspection object along the depth, to thereby form a modification beam in the reference unit 140. Then, the signal beam and the modification beam may be interfered with each other in the coupler 120, to thereby form modified interference beams at every position of the inspection object along the depth. The modified interference beams may be detected in the measuring unit 150, to thereby generate the 3-dimensional image on the object.

The measuring unit 150 may detect the interference beam generated in the coupler 120 and thus may generate digital image data on the object. For example, the measuring unit 150 may include an imaging device such as a CMOS chip and a CCD for converting the optical information into digital signals.

The frequency information on the selection beam L2 may be transferred to the measuring unit 150 from the wavelength detector 200. In addition, the digital image data generated on a basis of the selection beam L2 may be stored to each pixels of the imaging device. Thus, the frequency of the selection beam L2 may correspond to the pixel having the digital information for the image based on the selection beam L2 by one to one. Particularly, the digital image data on each cross-sectional surface of the inspection object may be linearly arranged along the depth of the object, to thereby facilitate the image correction along the depth of the object. Therefore, the resolution of the 3-dimensional image may be easily improved along the depth of the inspection object in the OCT 100.

Particularly, when the frequency sweeping laser beam may be used as the light source 110 and a plurality of the slits 241 on the flat plate 242 may be used as the wavelength detector 240, the frequencies of the sweeping laser beam may be linearly corrected with respect to time and position of the slits 241. Thus, the digital image data may be obtained based on the frequency components of the sweeping laser beam and the digital image data may be stored to pixels of the imaging device with respect to every frequency component by one to one. Therefore, the frequency and the pixel storing the digital image data may be mapped with each other by one to one, and the linearity between the frequency and the pixel may be obtained. Accordingly, when the 3-dimensional image of the OCT 100 may be somewhat dim and have a relatively lower resolution at a particular depth position, the pixel of which the resolution may be relatively lower and the frequency corresponding to the pixel may be linearly corrected based on the linearity between the pixel and the frequency.

According to the above example embodiment, the wavelength detector 200 may include the movable wavelength filter 240 by which a particular beam having a desired frequency may be easily selected as the selection beam, and the OCT 100 including the wavelength detector 200 may obtain the digital image data of the inspection object with respect to the frequency of every selection beam. The pixel having the digital image information and the frequency of an optical beam by which the digital image information may be generated may be mapped to each other by one to one, to thereby obtain the linearity between the pixel information and the frequency information. Accordingly, the resolution of the 3-dimensional image of the OCT 100 may be easily improved along the depth of the inspection object by controlling the frequency of the optical beam based on the linearity of the pixel and the frequency.

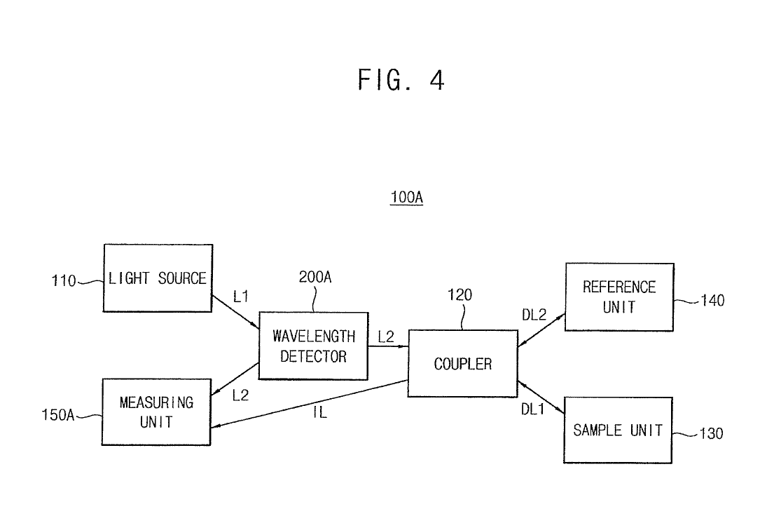

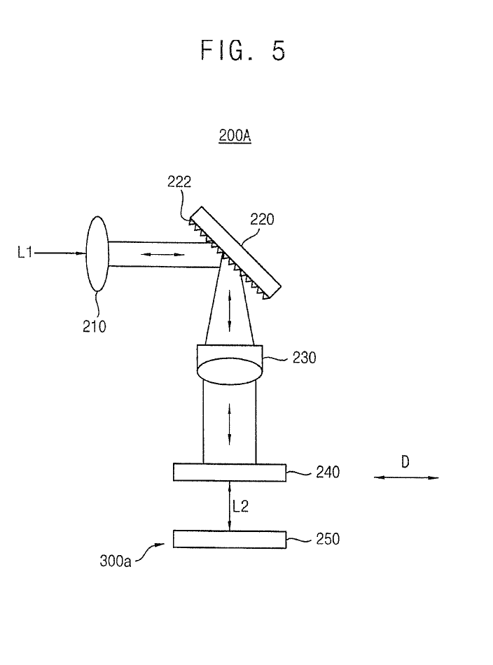

FIG. 4 is a bock diagram illustrating an OCT in accordance with a second example embodiment of the present inventive concept. FIG. 5 is a structural view illustrating a wavelength detector of the OCT shown in FIG. 4.

The OCT 100A in accordance with a second example embodiment of the present inventive concept has substantially the same structure as the OCT 100 shown in FIG. 1, except the wavelength detector. Thus, in FIGS. 4 and 5, the same reference numerals denote the same elements in FIGS. 1 and 2, and any further detailed descriptions on the same elements will be omitted hereinafter. In the second example embodiment, the OCT 100A includes a reflection type wavelength detector 200A rather than the transmitting type wavelength detector 200, and thus the configuration of the wavelength detector 200A and the measuring unit 150A is modified as compared with the first example embodiment of the OCT 100.

Referring to FIGS. 4 and 5, the OCT 100A in accordance with a second example embodiment of the present inventive concept may include a light source 110, a wavelength detector 200A, a coupler 120, a sample unit 130, a reference unit 140 and a measuring unit 150A. The wavelength detector 200A may include a first collimator 210, a first diffraction grating 220, a first focusing lens 230, a wavelength filter 240 and a light supplying unit 300a.

The first collimator 210 may transform the input light L1 radiated from the light source 110 into a parallel or a straight light and thus the input light L1 may be incident to the first diffraction grating 220 in parallel with a central axis of the first collimator 210.

The first diffraction grating 220 may split the input light L1 into frequency components thereof by diffraction and thus each frequency components of the input light L1 may be incident onto the first focusing lens 230. For example, the first diffraction grating 220 may include a flat glass plate or a concave metal plate on which a plurality of parallel lines may be engraved at a fine pitch, and thus the input light L1 may be split according to the frequencies thereof. That is, the first light L1 may be scattered into spectrums corresponding to each component frequency by the first diffraction grating 220. In the same way as the first example embodiment, the frequency component of the input light L1 is often referred to as a diffraction beam having a single frequency hereinafter.

The input light L1 may be diffracted into the diffraction beams by the first diffraction grating 220 and the diffraction beams may be focused onto the wavelength filter 240 by the first focusing lens 230.

The wavelength filter 240 may be positioned on a focal point of the first focusing lens 230 and may be reciprocated along a first direction D substantially perpendicular to an optical path of an incident light thereto. In the same way as described with reference to FIGS. 1 and 2 in first example embodiment of the OCT 100, one or more of the diffraction beams may be selected by the wavelength filter 240 as the selection beam L2 and the selection beam L2 may be provided to the light supplying unit 300a. For example, the wavelength filter 240 may include a flat plate having a single slit or a plurality of slits. When the wavelength filter 240 may include a flat plate having a single slit, one of the diffraction beams may be selected as the selection beam by reciprocating the wavelength filter along the first direction D. When the wavelength filter 240 may include a flat plate having a plurality of slits, some of the diffraction beams may be selected as the selection beams without reciprocation of the wavelength filter 240.

The light supplying unit 300a may include a single reflection mirror 250 in such a configuration that the selection beam L2 provided into the light supplying unit 300a may be reversely emitted out of the light supplying unit 300 along the same optical path. That is, the selective beam L2 may be reflected from the reflection mirror 250 of the supplying unit 300a and may pass reversely toward the wavelength filter 240, the first focusing lens 230, the first diffraction grating 220 and the first collimator 210 in the named sequential order. Therefore, the reflection mirror 250 may reflect the selection beam L2 in such optical conditions that the input light L1 and the selection beam L2 may pass through the same wavelength filter 240.

Therefore, the wavelength filter 240 may be controlled in such a way that the selection beam L2 may be reversely incident onto the first focusing lens 230 after reflection on the reflection mirror 250. For those reasons, the first diffraction grating 220 may include a two-way lattice plate 222 on which a plurality of incidence lattices and a plurality of reflection lattices may be mounted. The input light L1 may be guided to the first focusing lens 230 from the first collimator 210 by the incident lattices of the first diffraction grating 220, to thereby form an optical incidence path. The reflected selection beam L2 may be guided to the first collimator 210 from the first focusing lens 230 by the reflection lattices of the first diffraction grating 220, to thereby form an optical reflection path reverse to the optical incidence path. As a result, the input light L1 may be provided into the wavelength detector 200A and may pass along the optical incidence path to thereby select one (or some) of the diffraction beams of the input light L1 as the selection beam L2. In addition, the selection beam L2 may be reflected from the reflection mirror 250 of the light supplying unit 300a and thus may pass along the optical reflection path, to thereby emitting out of the wavelength detector 200A. Thus, the wavelength detector 200A may include a reflection type in which the inlet portion through which the input light L1 may pass into the wavelength detector 200A and the outlet portion through which the selection beam L2 may pass out of the wavelength detector 200A may be located at the same position.

The selection beam L2 having the desired frequency may be provided into both of the measuring unit 150 and the coupler 120. The coupler 120 may split the selection beam L2 into the first split beam DL1 and the second split beam DL2 that may be supplied to the sample unit 130 and the reference unit 140, respectively.

The measuring unit 150 may be connected to the wavelength detector 200A and the coupler 120 via the optical fiber. The reflected first and the second split beams DL1 and DL2 may be interfered with each other in the coupler 120 to thereby form the interference beam IL. The interference beam IL and the selection beam L2 may be detected in the measuring unit 150 to thereby generate the 3-dimensional digital image on the object.

According to the above example embodiment, the wavelength detector 200A may include the movable wavelength filter 240 by which a particular beam having a desired frequency may be easily selected as the selection beam, and the OCT 100A including the wavelength detector 200A may obtain the digital image data of the inspection object with respect to the frequency of every selection beam. The pixel having the digital image information and the frequency of an optical beam for generating the digital image information may be mapped to each other by one to one, to thereby obtain the linearity between the pixel information and the frequency information. Accordingly, the resolution of the 3-dimensional image of the OCT 100A may be easily improved along the depth of the inspection object by controlling the frequency of the optical beam based on the linearity of the pixel and the frequency. Particularly, the light supplying unit 300a may be simplified into a single reflection mirror, to thereby reducing down the manufacturing cost of the wavelength detector 200A including the light supplying unit 300a.

### INDUSTRIAL APPLICABILITY

According to the example embodiments of the present invention, the input light may be diffracted into a plurality of diffraction beams and the wavelength filter may select some of the diffraction beams having desired frequencies as the select beams by controlling the positions of the slits and the OCT including the wavelength filter may obtain digital image data of an inspection object with respect to the frequency of every selection beam. The pixel having the digital image information and the frequency of an optical beam for generating the digital image information may be mapped to each other by one to one, to thereby obtain the linearity between the pixel information and the frequency information. Accordingly, the OCT may obtain a 3-dimensional image of which the resolution may be uniform and have no image distortion.

Particularly, when the an inspection object in the OCT may be relatively so thick and deep downwards, the wavelength filter may be interposed between the coupler and the light source in such a configuration that the spectrum width of the diffraction beams may be inversely proportion to the depth of the object, thereby facilitating the resolution correction along the depth of the object.

In addition, the wavelength filter may include a plurality of slits on a flat plate and thus the frequency of the selection beam may be varied according to the position of the slit on the flat plate. A plurality of the selection beams may be simultaneously selected without the reciprocal movement of the wavelength filter due to the plurality of the slits. When the wavelength filter may include a single slit on the flat plate, a single selection beam may be selected by the wavelength filter and thus the wavelength filter may be required being reciprocated along a direction. However, when the wavelength filter may include a plurality of the slits, a plurality of the selection beams may be selected even though the wavelength may be stationary without the reciprocation movement. Accordingly, the mechanical instability caused by the reciprocation may be sufficiently prevented in the wavelength filter and thus the resolution of the 3-dimensional OCT image may become sufficiently uniform along the depth of the object. Further, since the slits may have different positions on the flat plate of the wavelength filter, the frequency of the selection beam that may be incident onto the measuring unit may be directly obtained from the position of the slit on the flat plate.

Although the exemplary embodiments of the present invention have been described, it is understood that the present invention should not be limited to these exemplary embodiments but various changes and modifications can be made by one skilled in the art within the spirit and scope of the present invention as hereinafter claimed.

1. A wavelength detector comprising:
a first collimator transforming an input light into a straight light, the input light being generated from an external light source;
a first diffraction grating diffracting the straight input light into a plurality of diffraction beams that are split according to frequencies thereof;
a first focusing lens focusing the diffraction beams to a first focal point;
a wavelength filter positioned on the focal point such that the diffraction beams are selectively filtered, thereby selecting at least a selection beam having a desired frequency; and
a light supplying unit emitting the selection beam outwards.

2. The wavelength detector of claim 1, wherein the wavelength filter includes a flat plate and a single slit penetrating the flat plate in such a configuration that one of the diffraction beams having the desired frequency corresponding to the slit passes through the slit of the wavelength filter to thereby select the single selection beam, so that a plurality of selection beams are selected by reciprocating the flat plate of the wavelength filter in a direction along which the diffraction beams are distributed as a spectrum distribution with respect to the frequencies thereof.

3. The wavelength detector of claim 2, wherein the wavelength detector includes an inlet through which the input light passes into the wavelength detector and an outlet through which the selection beam emits out of the wavelength detector, the inlet and the outlet being arranged at different positions individually, so that the input light is transformed into the selection beam in the wavelength detector and the selection beam passes out of the wavelength detector along an optical path different from that of the input light in the light supplying unit.

4. The wavelength detector of claim 3, wherein the light supplying unit includes:
a second focusing lens for focusing the selection beam that is selected by the wavelength filter;
a second diffraction grating diffracting the selection beam that is focused by the second focusing lens; and
a second collimator transforming the selection beam into a straight beam.

5. The wavelength detector of claim 2, wherein the wavelength detector includes an inlet through which the input light passes into the wavelength detector and an outlet through which the selection beam emits out of the wavelength detector, the inlet and the outlet being arranged at a same position, so that the input light is transformed into the selection beam in the wavelength detector and the selection beam passes out of the wavelength detector along a same optical path of the input light after reflected from the light supplying unit.

6. The wavelength detector of claim 5, wherein the light supplying unit includes a reflection mirror, so that the selection beam emits out of the wavelength detector sequentially passing through the wavelength filter, the first focusing lens, the first diffraction grating and the first collimator.

7. The wavelength detector of claim 6, wherein the first diffraction grating includes a two-way lattice plate on which a plurality of incidence lattices and a plurality of reflection lattices are mounted such that the input light is guided to the first focusing lens from the first collimator by the incident lattices to thereby form an optical incidence path and the selection beam may be guided to the first collimator from the first focusing lens by reflection from the reflection lattices to thereby form an optical reflection path reverse to the optical incidence path.

8. The wavelength detector of claim 1, wherein the wavelength filter includes a flat plate and a plurality of slits penetrating the flat plate and in parallel with one another in such a configuration that some of the diffraction beams having the desired frequencies corresponding to each slit pass through the slits of the wavelength filter, respectively, to thereby select a plurality of the selection beams without reciprocating the flat plate.

9. The wavelength detector of claim 8, wherein the slits include circular or polygonal openings penetrating through the flat plate and spaced apart by a same gap distance.

10. The wavelength detector of claim 8, wherein the frequency of the selection beam is measured by an optical spectrum analyzer.

11. The wavelength detector of claim 8, wherein the light supplying unit includes:
a second focusing lens for focusing the selection beam that is selected by the wavelength filter;
a second diffraction grating diffracting the selection beam that is focused by the second focusing lens; and
a second collimator transforming the selection beam into a straight beam.

12. The wavelength detector of claim 8, wherein the light supplying unit includes a reflection mirror, so that the selection beam emits out of the wavelength detector sequentially passing through the wavelength filter, the first focusing lens, the first diffraction grating and the first collimator.

13. The wavelength detector of claim 12, wherein the first diffraction grating includes a two-way lattice plate on which a plurality of incidence lattices and a plurality of reflection lattices are mounted such that the input light is guided to the first focusing lens from the first collimator by the incident lattices to thereby form an optical incidence path and the selection beam may be guided to the first collimator from the first focusing lens by reflection from the reflection lattices to thereby form an optical reflection path reverse to the optical incidence path.

14. An optical coherence tomography (OCT), comprising:
a light source for generating a broadband input light having a low coherence distance;
a wavelength detector diffracting the input light into a plurality of diffraction beams and selecting at least one of the diffraction beams as a selection beam having a desired frequency;
a coupler splitting the selection beam into first and second split beams and in which a pair of a signal beam and a reference beam are interfered into a single interference beam;
a sample unit in which an inspection object is positioned and to which the first split beam is transferred from the coupler, the sample unit forming the signal beam having optical information on internal structures of the inspection object by reflecting the first split beam from the inspection object;
a reference unit to which the second split beam is transferred from the coupler, the reference unit forming the reference beam by reflecting the second split beam there from; and
a measuring unit detecting the selection beam and the interference beam from the coupler, the measuring unit generating a digital image on the inspection object such that pixels having image data for the digital image are mapped to the frequency of the selection beam by one to one.

15. The OCT of claim 14, wherein the wavelength detector includes a first collimator transforming the input light into a straight light; a first diffraction grating diffracting the straight input light into a plurality of diffraction beams that are split according to frequencies thereof; a first focusing lens focusing the diffraction beams to a first focal point; a wavelength filter positioned on the focal point such that the diffraction beams are selectively filtered, thereby selecting at least a selection beam having a desired frequency; and a light supplying unit emitting the selection beam outwards.

16. The OCT of claim 15, wherein the wavelength filter includes a flat plate and a single slit penetrating the flat plate in such a configuration that one of the diffraction beams having the desired frequency corresponding to the slit passes through the slit of the wavelength filter to thereby select the single selection beam, so that a plurality of selection beams are selected by reciprocating the flat plate of the wavelength filter in a direction along which the diffraction beams are distributed as a spectrum distribution with respect to the frequencies thereof.

17. The OCT of claim 15, wherein the wavelength filter includes a flat plate and a plurality of slits penetrating the flat plate and in parallel with one another in such a configuration that some of the diffraction beams having the desired frequencies corresponding to each slit pass through the slits of the wavelength filter, respectively, to thereby select a plurality of the selection beams without reciprocating the flat plate.

18. The OCT of claim 14, wherein the wavelength detector is interposed between at least one of a pair of the light source and the coupler, a pair of the coupler and the sample unit, a pair of the coupler and the reference unit and a pair of the coupler and the measuring unit.

19. The OCT of claim 14, wherein the light source includes one of a light emitting diode (LED), a super luminescent diode (SLD), a laser diode (LD) and a frequency sweeping laser source.

20. The OCT of claim 14, wherein the reference unit includes one of a moving reflector and a combination of a stationary reflector and a scattering corrector, the moving reflector being movable along an optical path of the second split beam and reflecting the second split beam to thereby form the reference beam using the movable reflector and the scattering corrector correcting spectrum characteristics of the second split beam reflected from the stationary reflector to thereby form the reference beam using the stationary reflector.
